(19) United States
(12) Patent Application Publication
(10) Pub. No.: US 2008/0124465 A1
(43) Pub. Date: May 29, 2008

(54) Process For Producing Optical Multilayer Film Filter And Optical Multilayer Film Filter

(75) Inventors: Yoshikazu Yamaguchi, Kawasaki (JP); Masaaki Yonekura, Tochigi (JP); Toyo Ohtsuki, Tochigi (JP)

Correspondence Address: CROWELL & MORING LLP;INTELLECTUAL PROPERTY GROUP, P.O. BOX 14300, WASHINGTON, DC, 20044-4300, US

(73) Assignee: Central Glass Company, Limited, Ube-shi, Yamaguchi (JP)

(21) Appl. No.: 11/792,367

(22) PCT Filed: Dec. 22, 2005
(86) PCT No.: PCT/JP05/23643

§ 371 Date: Jun. 6, 2007

(30) Foreign Application Priority Data
Jan. 6, 2005 (JP) 2005-001195

(51) Int. Cl. B05D 3/10

(52) U.S. Cl. 427/270

(57) ABSTRACT

The present invention relates to a process for producing an optical multilayer film filter comprising the steps of forming a resin layer on a substrate; forming a multilayer film on the resin layer; and detaching the multilayer film from an interface with the resin layer.

### TECHNICAL FIELD

The present invention relates to a process for producing an optical multilayer film filter that multiplexes or demultiplexes lights of particular wavelengths in optical communications, and particularly relates to a process for producing an optical multilayer film filter that consists of a multilayer film by removing a substrate for forming the multilayer film after the formation of the multilayer film and that is a so-called substrateless filter and to the optical multilayer film filter.

### BACKGROUND OF THE INVENTION

Optical multilayer film filter that multiplexes or demultiplexes lights of particular wavelengths plays an important role in optical devices and optical parts used in optical communication systems. This is one that has a transparent multilayer film formed on a substrate and that multiplexes or demultiplexes lights of particular wavelengths by thin-film interference of light. This is used by an insertion into an optical path. Along with the trend to small-size devices, a thinner one is required for reducing the optical loss of the optical multilayer film filter itself. Nowadays, the thickness of an optical multilayer film filter is required to be about several tens of micrometers or less, and further thinner ones have also been requested.

As a means for solving these, there is a process of using a resin such as polyimide for the substrate, in place of conventional glass-substrate, optical multilayer film filters that are brittle, inferior in workability and not good in yield. It is possible by this process to produce optical multilayer film filters having thicknesses of about several tens of micrometers or less with high yields (for example, see Patent Publication 1).

However, the technical progress has caused a request for thinner optical multilayer film filters in order to further reduce the optical loss. On the one hand, there has been a request for high-performance optical multilayer film filters. In some cases, only multilayer ones having 100 layers or more can satisfy the requested performance. The multilayer film naturally becomes thicker in thickness by increasing the number of layers. This cannot satisfy the request for thinner ones. In this case, it is natural to plan to make the substrate thinner, which does not have an influence on the thin-film interference of light, that is, on the performance. Furthermore, there is a request for making the communication wavelength band wider, but it is preferable that a resin substrate, such as polyimide, having an absorption at far infrared has a thickness as thin as possible.

Making the substrate thinner has been examined by these reasons, but it has finally reached a request for a filter of only an optical multilayer film, which is free from the substrate itself, that is, a so-called substrateless filter. As its preparation process, there has been developed a process of obtaining a substrateless filter by forming a multilayer film, for example, on a soluble substrate and then dissolving the substrate (see, for example, Patent Publications 2 and 3).

### Patent Publication 1: Japanese Patent No. 2608633

### Patent Publication 2: Japanese Patent Laid-open Publication No. 3-274506

### Patent Publication 3: Japanese Patent No. 3423147

### SUMMARY OF THE INVENTION

It is an object of the present invention to provide a substrateless filter as an optical multilayer film filter that is further thinner than conventional optical multilayer film filters, its easy production process, and optical parts using this.

The presently disclosed processes for producing substrateless filters have the following problems.

That is, presently known processes are those in which a soluble substrate is used and in which the substrate is dissolved after the formation of an optical multilayer film. For example, there are cited substrates of water-soluble NaCl and KBr and acid-soluble Al and the like in the above-mentioned Japanese Patent Laid-open Publication No. 3-274506 and Japanese Patent No. 3423147.

However, a flat substrate such as NaCl or KBr has an extremely high price. This leads to the cost increase. Furthermore, these materials have a hygroscopic property, and therefore there is a problem of necessity of having careful handling. Although a metal substrate such as Al has a low price, the time necessary for the detachment varies since solubility in acid becomes different depending on the oxidation condition of the substrate surface. Furthermore, the surface oxidized layer may adhere to the filter backside to affect the characteristics.

Furthermore, separation grooves having a size corresponding to that of filter chips are previously formed in the substrate in the above patent, but the film thickness near the grooves tends to become thin as compared with a portion away from the grooves. With this, characteristics of a peripheral portion of the obtained filter chips become different from those of the center. However, the depth of an opening is limited in planar lightwave circuit (PLC) modules and the like. Therefore, there are also many cases in which an optical path does not come to a central portion of the filter inserted, but to a peripheral portion. Thus, it is problematic that characteristics of the peripheral portion are different from those of the central portion.

In order to avoid this problem, it is possible to think about a process of forming separation grooves with a dicer or the like after the formation of a dielectric multilayer film. However, in case that the substrate is hard, vibration occurs upon dicing, and chipping occurs at a peripheral portion of the dielectric multilayer film along the separation grooves. As a result, there is a problem that the filter chips after the detachment will have many occurrences of cracks and breaks and chipping defects of the peripheral portion.

As mentioned above, there is a demand for a so-called substrateless filter, but a process of easily producing this substrateless filter with high yield is not yet obtained.

According to the present invention, there is provided a process for producing an optical multilayer film filter comprising the steps of forming a resin layer on a substrate; forming a multilayer film on the resin layer; and detaching the multilayer film from an interface of the resin layer.

Furthermore, according to the present invention, there is provided an optical multilayer film filter produced by the above process.

### DETAILED DESCRIPTION

In the following, the present invention is exemplarily described in detail.

The present invention is one usable in the optical device field, electronic material field and the like and a field using thin-film multilayer films, and particularly in case that there is a need for thinner thin-film multilayer films.

According to the present invention, it is possible to produce a so-called substrateless filter of high performance with high yield by an easy process.

The substrate for forming a resin layer has a function of holding soft resin and preventing deformation of the resin layer, particularly warping due to the film stress, upon forming the multilayer film. Metal plate, glass plate and the like can be used. In the case of conducting the film thickness control by transmittance upon forming the multilayer film, glass plate or the like, which transmits a light of the wavelength of the control light, is preferable.

The above-mentioned process for producing an optical multilayer film filter may have the step of cutting the multilayer film and the resin film into desired sizes, between the step of forming the multilayer film and the detaching step.

The cutting step is not necessary, if the size of the desired filters is the same as that of the substrate for forming the resin layer. However, in the case of inserting the filters among optical fibers and waveguides, the size of the filter chips is a several millimeters square or less. Therefore, it is preferable to cut them into a desired size after the formation of the multilayer film.

The resin may be fluorinated polyimide.

Fluorinated polyimide, which is high in high-temperature stability among resins, is preferable, since it becomes high temperature upon forming the multilayer film depending on the film-forming means. There are many cases in which the film thickness control of the multilayer film is conducted by the transmitted light. In those cases, it is necessary that the resin, together with the substrate for forming the resin layer, also transmits the light of the wavelength of the control light. In such cases, fluorinated polyimide, which is high in transmittance in a wide wavelength range from the visible to the infrared region, is a preferable material.

Of fluorinated polyimides, one that is higher in fluorination is preferable. This is because one that is higher in fluorination is weaker in adhesion between an oxide that is a general multilayer film material, such as SiO₂, TiO₂ and Ta₂O₅, and fluorinated polyimide and because it is easy to detach the multilayer film in the following detaching step. For example, as compared with a fluorinated polyimide having PMDA structure represented by the following formula,

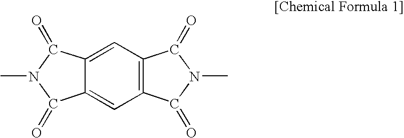

a fluorinated polyimide having 6FDA structure, which is represented by the following formula,

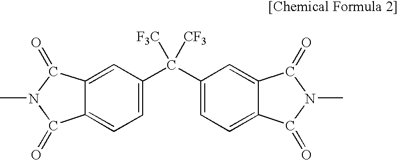

is more preferable. Furthermore, among polyimides having TFDB structure which is represented by the following formula,

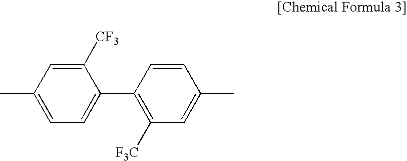

a 6FDA/TFDB polyimide which is represented by the following formula,

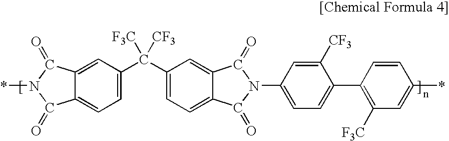

is more preferable. Furthermore, for example, a perfluorinated polyimide represented by the following formula,

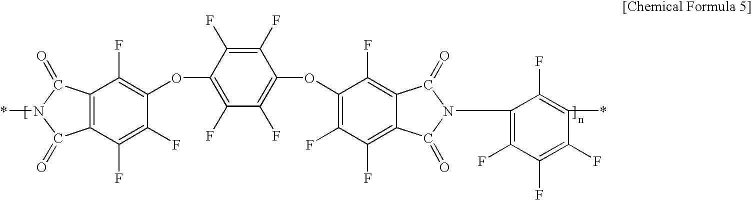

is also preferable due to the same reason. Even if it is a polyimide containing PMDA/TFDB structure represented by the following formula,

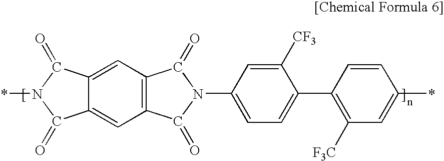

which is low in fluorination degree, a preferable result is similarly obtained, as long as the polyimide is a bicomponent-series polyimide that has 6FDA/TFDB structure and PMDA/TFDB structure and that is a copolymer of which 6FDA/TFDB content is 50 mol % or greater. Furthermore, a mixture of a perfluorinated polyimide and 6FDA/TFDB polyimide in any ratio is similarly preferable as a fluorinated polyimide of the present invention.

As a process of detaching the optical multilayer film from the fluorinated polyimide film, it is possible to obtain filters of a predetermined size, for example, by forming separation grooves (cuttings) of a depth reaching from the optical multilayer film side to an upper portion of the fluorinated polyimide film or the substrate and then by immersing it in water or hydrochloric acid aqueous solution, thereby detaching the optical multilayer film from the fluorinated polyimide film.

In the process of forming the multilayer film on the resin of the present invention, it is also preferable for a process of making cuttings from the multilayer film side by a rotary blade such as dicer. In general, cracks and breaks tend to occur at the cuts by making such grooves. This becomes a cause of lowering the yield of the final filter chips. When a resin layer, however, exists below as in the present invention, the resin layer acts to suppress vibration of the rotary blade. Therefore, it is possible to prevent cracks and breaks of the cuts.

Furthermore, it is possible to naturally detach the multilayer and the resin layer from each other by immersion in water or hydrochloric acid aqueous solution after forming the separation grooves. Since it is not a detachment by mechanical method, it is possible to obtain a filter of only multilayer (substrateless filter) with high yield, without generating cracks and breaks of the filter.

In the following, the present invention is explained by examples. The present invention is, however, not limited to these examples.

### EXAMPLE 1

A normal soda-lime-silicate glass of 4 mm thickness and 100 mmφ was prepared as a substrate. A polyimide varnish that became a raw material of a polyimide film was applied to this substrate by spin coating, followed by baking under nitrogen atmosphere at 380° C. for 60 min, thereby obtaining a polyimide film of 6FDA/TFDB of 10 μm in thickness. The thickness of the polyimide film is a value measured by probe method after partly taking off a film formed under the same condition.

This substrate was set in an APS (advanced plasma source) deposition apparatus, and a multilayer film was formed by SiO₂—Ta₂O₅ alternate layers of 96 layers. The thickness of the multilayer film was about 20 μm.

The obtained substrate with the multilayer film was set at a dicer, and it was cut into a predetermined chip size to a depth of 35 μm from the optical multilayer film side. The cutting treatment portion is in a 40 mm square at around the substrate center, and the chip size is 0.5 mm×2 mm.

Then, the substrate was totally immersed in pure water for 48 hr, and the multilayer film was detached from the glass substrate and the polyimide film, thereby obtaining the target optical thin-film filter. In case that the separation grooves have been formed to a depth reaching the substrate, the polyimide film of the same shape as that of the target filter is also detached from the substrate. It is, however, possible to easily separate it in a liquid since it has a lower specific gravity as compared with that of the target filter.

The obtained filter chips were subjected to a visual inspection with a polarization microscope. With this, of the total chips of 1,600, defective products were 155 in total, in which ones by surface scratch were 45, ones by foreign objects in the multilayer film were 13, ones by cracks of the chips were 50, and ones by breaks of the chips in total were 47. The non-defective product percentage (yield) was 90.3%, which was extremely good.

### EXAMPLE 2

A normal soda-lime-silicate glass of 4 mm thickness and 100 mmφ was prepared as a substrate. A polyimide varnish that became a raw material of a polyimide film was applied to this substrate by spin coating, followed by baking under nitrogen atmosphere at 380° C. for 60 min, thereby obtaining a polyimide film of 10 μm in thickness of a 6FDA/TFDB-PMDA/TFDB, bicomponent-series copolymer having a 6FDA/TFDB content of 60 mol %. The thickness of the polyimide film is a value measured by probe method after partly taking off a film formed under the same condition.

This substrate was set in an RF ion beam sputtering apparatus, and a multilayer film was formed by SiO₂—Ta₂O₅ alternate layers of 96 layers similar to Example 1. The thickness of the multilayer film was about 20 μm.

The obtained substrate with the multilayer film was set at a dicer, and it was cut into a predetermined chip size to a depth of 25 μm from the optical multilayer film side. The cutting treatment portion is in a 40 mm square at around the substrate center, and the chip size is 0.5 mm×2 mm.

Then, the substrate was totally immersed in 1 mol % HCl aqueous solution for 72 hr, and the multilayer film was detached from the glass substrate and the polyimide film, followed by washing well with pure water, thereby obtaining the target optical thin-film filter.

The obtained filter chips were subjected to a visual inspection with a polarization microscope. With this, of the total chips of 1,600, defective products were 145 in total, in which ones by surface scratch were 51, ones by foreign objects in the multilayer film were 15, ones by cracks of the chips were 33, and ones by breaks of the chips in total were 46. The non-defective product percentage (yield) was 90.9%, which was extremely good.

### COMPARATIVE EXAMPLE 1

An Al of 3 mm thickness and 100 mmφ was prepared as a planar smooth substrate.

This substrate was set in an APS (advanced plasma source) deposition apparatus, and a multilayer film was formed by SiO₂—Ta₂O₅ alternate layers of 96 layers similar to Examples. The thickness of the multilayer film was about 20 μm.

The obtained substrate with the multilayer film was set at a dicer, and it was cut into a predetermined chip size to a depth of 25 μm from the optical multilayer film side. The cutting treatment portion is in a 40 mm square at around the substrate center, and the chip size is 0.5 mm×2 mm.

Then, the substrate was totally immersed in 3 mol % HCl aqueous solution for 48 hr, thereby dissolving the Al substrate and detaching the multilayer. Then, it was washed well with pure water, thereby obtaining the target optical thin-film filter.

The obtained filter chips were subjected to a visual inspection with a polarization microscope. With this, of the total chips of 1,600, defective products were 882 in total, in which ones by surface scratch were 40, ones by foreign objects in the multilayer film were 10, ones by cracks of the chips were 232, ones by breaks of the chips in total were 253, and ones having a foreign object adhering to their surface were 347. The non-defective product percentage (yield) was a low value of 44.9%. By an analysis of the foreign object adhering to the surface with fluorescent X-ray, Al and Cl were detected. Therefore, this foreign object is considered to be AlCl₃.

1. A process for producing an optical multilayer film filter comprising the steps of forming a resin layer on a substrate; forming a multilayer film on the resin layer; and detaching the multilayer film from an interface with the resin layer.

2. A process for producing an optical multilayer film filter according to claim 1, further comprising the step of cutting the optical multilayer film and the resin layer into a desired size, between the step of forming the multilayer film and the detaching step.

3. A process for producing an optical multilayer film filter according to claim 1, which is characterized in that the resin layer is a fluorinated polyimide film.

4. A process for producing an optical multilayer film filter according to claim 3, wherein the optical multilayer film is detached from the fluorinated polyimide film by an immersion in water or hydrochloric acid aqueous solution in the detaching step.

5. A process for producing an optical multilayer film filter according to claim 4, where a process of detaching the optical multilayer film from the fluorinated polyimide film is characterized in that a separation groove of a depth reaching from a side of the optical multilayer film to an upper portion of the fluorinated polyimide film or the substrate is formed, followed by immersion in water or hydrochloric acid aqueous solution, thereby detaching the optical multilayer film from the fluorinated polyimide film and obtaining the filter of a predetermined size.

6. A multilayer film filter produced by a process according to claim 1.
